(19) United States
(12) Patent Application Publication
(10) Pub. No.: US 2004/0238298 A1
(43) Pub. Date: Dec. 2, 2004

(54) Multifunction braking and suspension device for a motorcycle or other vehicle

(76) Inventor: Charles Nash, Whites Creek, TN (US)

Correspondence Address: Charles Nash, 5455 Buena Vista Pike, Whites Creek, TN, 37189, US

(21) Appl. No.: 10/833,824

(22) Filed: Apr. 26, 2004

Related U.S. Application Data
(60) Provisional application No. 60/467,774, filed on Apr. 28, 2003.

(51) Int. Cl. B60G 1/00

(52) U.S. Cl. 188/152; 280/124.1

(57) ABSTRACT

A brake caliper mounting assembly and an adjustable torsion arm are retrofitted or designed into the construction of a motorcycle or other vehicle in order to provide multiple functions related to the braking and suspension of the vehicle. The caliper housing assembly and torsion arm are attached to the axle and frame of the motorcycle in one embodiment in order to provide a simultaneous combination of lowering the vehicle's center of gravity and safer braking and control while the motorcycle is in forward motion as the rear brakes or the rear and front brakes are applied together.

### CROSS REFERENCE TO RELATED APPLICATIONS

Provisional Patent Application filed by Charles T. Nash, Whites Creek, Tenn., the Applicant here, as a Small Entity, Titled, “Inertia brake system which provides down force on the rear wheel or wheels of a vehicle under heavy braking,” filing date: Apr. 28, 2003, application Ser. No. 60/467,774

### STATEMENT REGARDING FED SPONSORED R&D

N/A

### REFERENCES—PRIOR ART

### Prior Art

### References Cited (Referenced By)

### U.S. Patent Documents

U.S. Pat. No. 657,667 September, 1900 Mills

U.S. Pat. No. 1,047,430 December, 1909 Leet, et. al.

U.S. Pat. No. 2,132,317 October, 1938 Pease

U.S. Pat. No. 2,446,731 August, 1948 Wheler

U.S. Pat. No. 3,942,821 March, 1976 Bock

U.S. Pat. No. 4,058,181 November, 1977 Buell

U.S. Pat. No. 4,421,337 December, 1983 Pratt

U.S. Pat. No. 4,529,056 July, 1985 Kreuz

U.S. Pat. No. 4,641,731 February 1987 Kawaguchi, et. al.

U.S. Pat. No. 4,660,683 April, 1987 Hayashi, et. al.

U.S. Pat. No. 4,789,174 December, 1988 Lawwill

U.S. Pat. No. 5,121,937 June, 1992 Lawwill

U.S. Pat. No. 5,205,572 April 1993 Buell, et. al.

U.S. Pat. No. 5,226,674 July 1993 Buell, et. al.

U.S. Pat. No. 5,259,637 September, 1993 Busby

U.S. Pat. No. 5,259,637 November 1993 Busby

U.S. Pat. No. 5,295,702 March, 1994 Buell

U.S. Pat. No. 5,360,078 November 1994 Rifenberg, et. al.

U.S. Pat. No. 5,306,036 April 1994 Busby

U.S. Pat. No. 5,441292 August 1995 Busby

U.S. Pat. No. 5,492,205 February 1996 Zhang

U.S. Pat. No. 5,620,237 April 1997 Iwashita, et. al.

U.S. Pat. No. 5,839,536 November, 998 Tanaka

U.S. Pat. No. 5,992,587 November 1999 Maldonado

U.S. Pat. No. 6,178,613 January, 2001 Monson

U.S. Pat. No. 6,056,307 May, 2000 Busby

U.S. Pat. No. 6,182,993 February 2001 Berkmann

U.S. Pat. No. 6,283,255 September 2001 Gardner, et. al.

U.S. Pat. No. 6,357,546 March 2002 Crosby, Jr.

U.S. Pat. No. 6,382,374 May 2002 Iwai, et. al.

U.S. Pat. No. 6,386,340 May 2002 Milesi, et. al.

U.S. Pat. No. 6,388,533 January 2002 Wakabayashi, et. al.

U.S. Pat. No. D454,819 March 2002 Nakazawa

U.S. Pat. No. 6,427,796 August 2002 Tsutsumikoshi

U.S. Pat. No. 6,485,043 November 2002 Ito, et. al.

U.S. Pat. No. 6,520,524 February 2003 Costa

U.S. Pat. No. 6,581,715 June 2003 Montague

U.S. Pat. No. 6,561,298 May 2003 Buell, et. al.

U.S. Pat. No. 6,611,743 August 2003 Sakai

U.S. Pat. No. 6,648,352 November 2003 Felsing

U.S. Pat. No. 6,672,419 January, 2004 Buell, et. al.

U.S. Pat. No. 6,691,814 February 2004 Toyoda

U.S. Pat. No. 6,715,848 April 2004 Chen, et. al.

Other References:

“Advanced Motorcycle Braking,” MotorCycle Cruiser, Apr. 3, 2004

“Riding Skills Series: Countermeasures” Sport Rider, April, 2004.

### BACKGROUND OF THE INVENTION

1. Field of the Invention

The Invention is an apparatus which provides multiple functions related to the suspension and braking for a motorcycle or other vehicle. The invention further relates to the use of a rear disc brake caliper mounting, which is also part of the subject invention as shown in the enclosed drawings, and is attached by means of other components of the subject invention to the frame of the motorcycle so as to provide enhancement to the braking of the vehicle using the forward force of said vehicle to provide a downward force to the rear of the vehicle and lowering the center of gravity under braking conditions of the application of the rear brake, or the front and rear brakes applied simultaneously.

2. Related Art

The rider of a motorcycle typically applies the braking system of said vehicle using one of either the rear brakes or the front brake systems, or both the front and rear brakes simultaneously, of the vehicle through levers on the handlebars of the vehicle or through a foot activated brake pedal or pedals. Prior art such as taught by Busby, et. al. at U.S. Pat. No. 6,056,307, teaches that “a braking assembly is configured such that the engagement thereof to the braking surface facilitates the transfer of braking force to and the actuation of the rear wheel suspension mechanism in a manner countering the unweighting thereof normally resulting from the braking of the bicycle.” Busy refers to a bicycle which does not employ a rear disc brake caliper mounting and mechanism, unlike a motorcycle or other vehicle employing said system or systems. Although the subject invention claims herein to provide an “anti-dive” function, as does Busby, it teaches this, along with other suspension functions, through novel means and apparatus distinct from Busby.

A combination brake rotor and belt pulley assembly for a motorcycle is taught by Maldonado at U.S. Pat. No. 5,992,87, and, unlike the subject invention, said invention does not claim the braking efficiency of the vehicle or to lower the center of gravity in order to provide a Maldonado, does teach a combination of component functions of a motorcycle, with the suspension components attached to the motorcycle frame, as detailed in the enclosed drawings.

Various prior art inventors employ such methods as dual hydraulic master cylinders, as in Iwashita, et. al., U.S. Pat. No. 5,620,327, and hydraulic cut-off valves, as in Suzuki, et.al, U.S. Pat. No. 5,573,313 in order to improve or control motorcycle braking.

### SUMMARY OF THE INVENTION

The Applicant inventor provides a novel and utilitarian assembly which can be either designed into or retrofitted to existing motorcycles—in one embodiment the device can fit onto the existing frame and rear suspension, including the stock original equipment of a Harley Davidson Road King, and the Applicant's invention of a brake caliper mount and housing combined with an adjustable torque arm, both of which are attached by conventional means of bolts and nuts to the vehicle's frame, and may also include the originally equipped, hydraulically activated disc brake caliper and brake pads, including original equipment or replacement brake lines attached thereto.

The Applicant's invention provides further that under braking conditions, where the rear and front brakes are applied together or the rear brake applied solely, that the rear suspension, because of the Applicant's device, is compressed and causes the rear of the underway; the added utility and benefit is that the handling of the vehicle is affected only under braking, and then in a favorable aspect whereby the down-force on the rear tire affected by the aforesaid compression substantially increases the braking ability of the or slows. At the same time, the front steering and suspension fork of the motorcycle, in the embodiment described here, is not bending forward or engaging the vehicle in a “dive” forward under braking because the suspension and braking system and assembly of the Applicant is supplying down-force to the rear of the vehicle, tending to keep the front steering fork in its original position or even more favorably positioned so as to substantially avoid the tendency of the vehicle to “dive” as the rear of the vehicle experiences the aforementioned down-force; whereby the Applicant's device favorably and substantially alters the steering head and front fork angle of the vehicle when braking under the aforesaid conditions.

A further benefit and utility is demonstrated in the Applicant's invention by the ability of hand or foot operated mechanisms conventionally found on motorcycles and other vehicles without skidding or lockup due to the gradually lowering center of gravity underway when the driver or rider applies either the rear brakes or the rear and front brakes together. The rider or driver is controlling both the lowering of the center of gravity and the braking effectiveness simultaneously through application of the rear brake or the front and rear brakes together.

Applicant provides a novel and utilitarian device and assembly which can be retrofitted to existing motorcycles in order to provide a safer more effective braking and suspension system. The utility of the Applicant's device relies on at least one embodiment on a Harley Davidson motorcycle in that the device becomes integral to the vehicle's original braking and suspension system itself, and no new holes have to be drilled into the structure of the existing vehicle or in any way does the Applicant's invention negatively affect the structural integrity of the existing vehicle. In this described embodiment the Applicant provides a kit which can be directly bolted onto the existing vehicle.

### BRIEF DESCRIPTION OF DRAWINGS

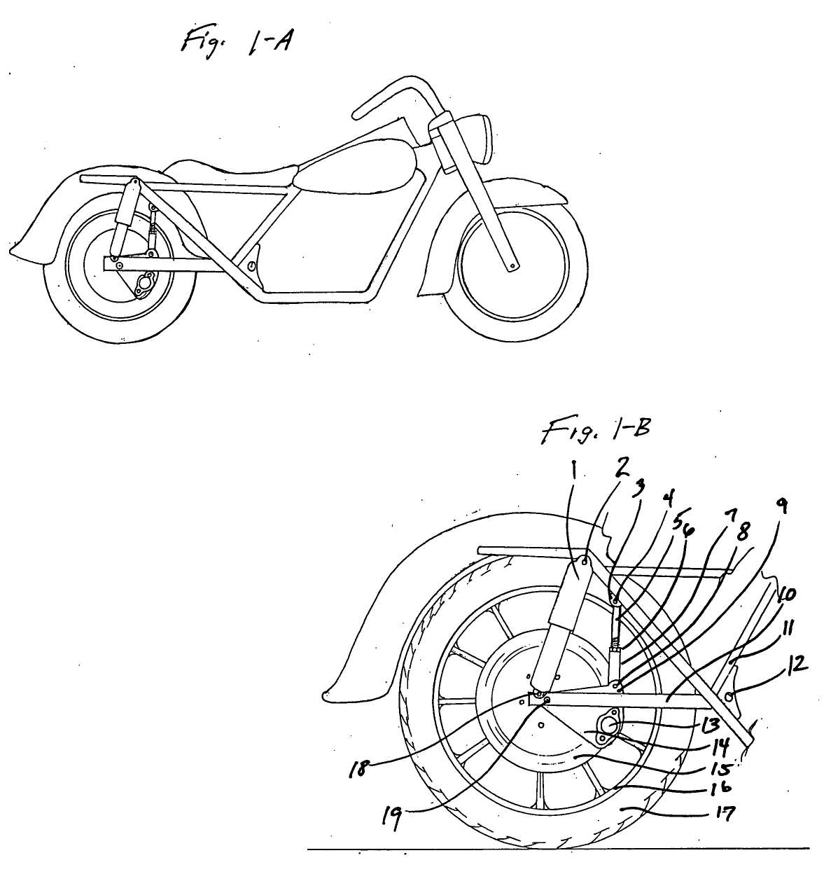

In FIG. 1-A, Applicant's device is shown attached to the back axle assembly of a motorcycle, in one embodiment, at (19), and the entire assembly of the invention is fitted inside of the swingarm (10), and next to and fitted over the existing disc brake rotor (15), and attached to the swingarm at (19), with the existing caliper mechanism, including brake pads (13) attached at the Applicant's caliper mount (14), said assembly further attached to the adjustable torque arm (5), (6) and (7) which in turn is attached to the upper frame of the motorcycle (3).

Pivot points of the Applicant's invention are at each point of attachment as outlined above, and also at the existing vehicle's shock absorber mounts (2) and (18) and the swingarm pivot point at the vehicle's frame (12).

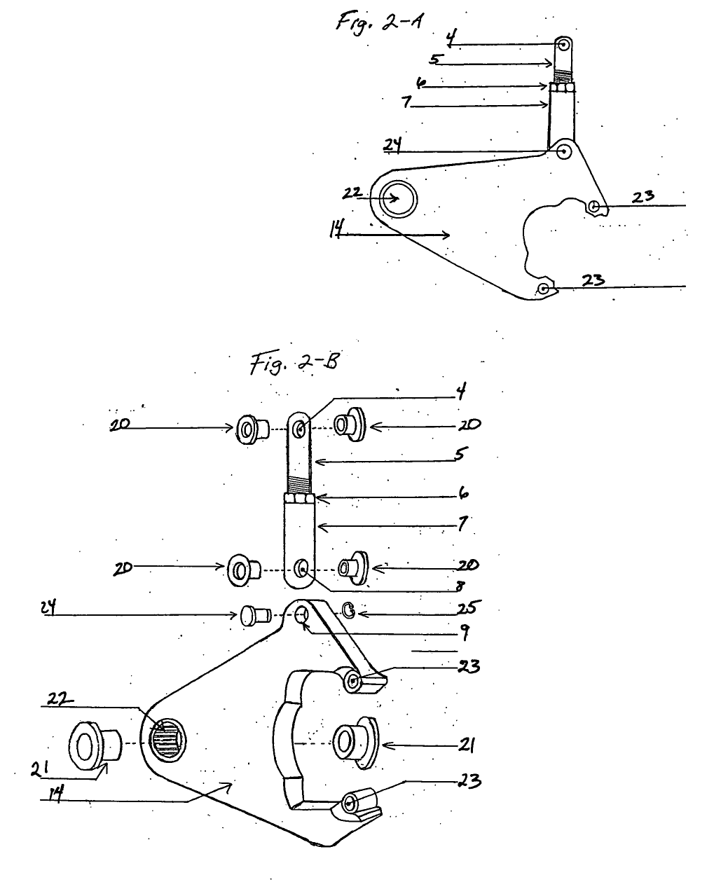

In FIG. 2-A, Applicant's apparatus is shown in side view as if in the same position as in FIG. 1-A to be attached to the motorcycle there described. The Applicant's disc brake caliper mount, (14), in one embodiment, is made of durable 6061 T6 aluminum or other comparable metal, polished to match the custom and existing accessories of the motorcycle, and attached at (9) to the lower strut (7) of the adjustable torque arm (5), (6) and (7), by a bolt (24) with a special vibration absorbing bushing (20) at that point (4) and (8), and by a female thread and jam nut (6) attached to the lower strut (7) and the upper strut (5) with a male thread whose upper bolt hole (4) is attached to the motorcycle's frame mounting bracket (3).

### DETAILED DESCRIPTION OF A PREFERRED EMBODIMENT

FIGS. 1-A and 1-B: FIG. 1-A a schematic right side view of a stock equipped motorcycle with a swing-arm frame equipped with the Applicant's invention. FIG. 1-B is a close-up view of the rear of the same vehicle also from the right side, with the Applicant's device in detail. According to FIG. 1-B, Applicant's disc brake caliper mount (14) attaches to the rear axle of the vehicle at (19) and in close proximity to the lower mount (18) of the existing shock absorber of the motorcycle illustrated in FIGS. 1-A and 1-B.

In FIG. 1-B, a stock type of disc brake caliper with stock mounting apparatus (13) is attached to the Applicant's disc brake caliper mounting device (14). In FIG. 2-A a greater detail view of FIG. 1-B is shown with specific detail at the two bolt mounting holes (23) denoting where the stock type of disc brake caliper is bolted to the Applicant's disc brake caliper mount (14). Also noted in FIG. 2-A is the axle mounting point at a needle bearing (22) pressed into (14) on the rear of the motorcycle of the Applicant's caliper mounting device, and another bolted mounting point (24) where the Applicant's adjustable torque arm, (5), (6) and (7) is attached to (14) and at the upper part of said arm, (5) and (4) to the upper frame (3) of the motorcycle as noted in FIGS. 1-A and 1-B.

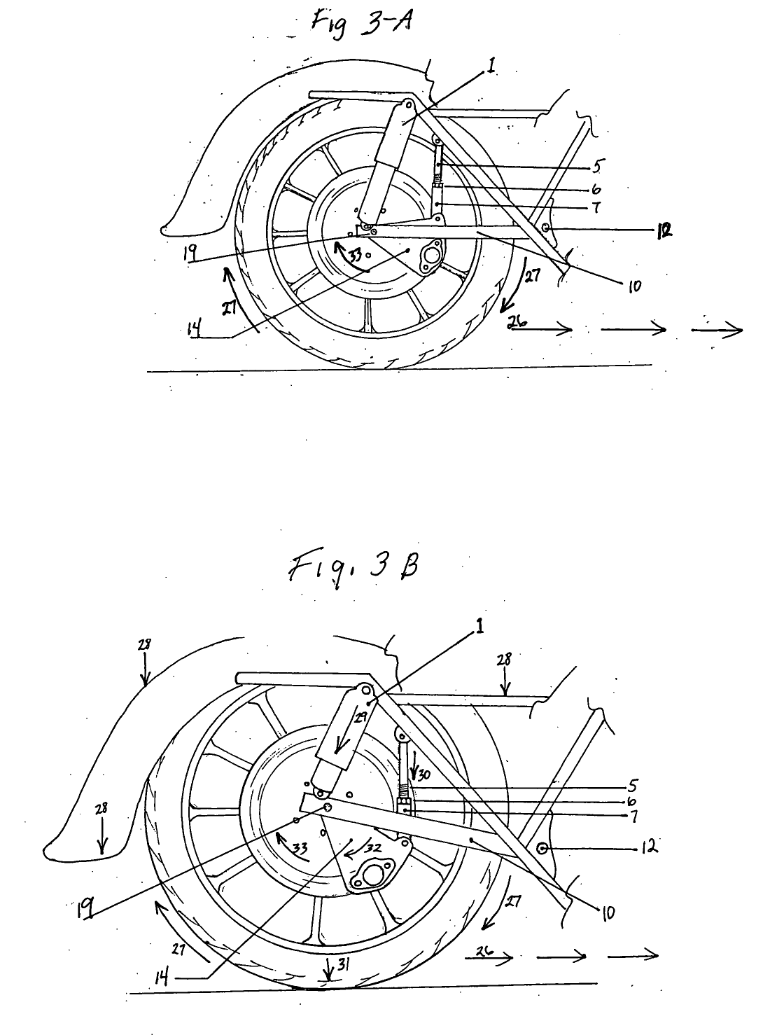

In FIG. 2-B, Applicant's multifunction device illustrates the mounting mechanisms (20), (21), and (24) in addition to a fastening device (25) and needle bearing (22), which acting in concert as illustrated at FIGS. 3-A and 3-B, also supply a dampening and anti-vibration effect to the multiple functions of the Applicant's device on the preferred embodiment on the motorcycle illustrated.

FIGS. 3-A and 3-B show the multiple functions of Applicant's device in its preferred embodiment on a motorcycle. FIG. 3-A shows the motorcycle traveling in a forward direction (26), (27) and (33) without the rear brakes or the front brakes being applied, and with Applicant's brake caliper mounting device (14) and torque arm (5), (6), and (7) in a position able to move in concert with the standard equipped suspension (1), (10) and (12) of the motorcycle, but not acting in any way to lower the center of gravity of the vehicle until the rear brakes, or the rear brakes and the front brakes are applied as shown in FIG. 3B.

FIG. 3-B shows that as the rear brakes or the rear brakes and front brakes are applied at the same time, said application of braking acts to move the Applicant's device (14) in the same direction (32) of travel as the disc brake rotor (33) around the motorcycle's axle at (19). Simultaneously, and as a direct result of the movement of the said device (14) and the torque arm, (5), (6) and (7) whose movements are both circular and counterclockwise (32), (33) and downward (28) and (30) as shown in FIG. 3-B, the effect of these movements is to pull the rear of the motorcycle downward in a manner which can be controlled by the force of braking applied by the rider or driver through the standard equipped disc brake caliper attached to the Applicant's disc brake caliper mounting (14) and torque arm (5), (6) and (7). The resulting effect is to lessen the motorcycle's tendency to “dive” forward on its front wheel forks while the said driver-controlled braking and lowering of the center of gravity of the motorcycle provides for better, safer control of the vehicle under braking.

While the Applicant's invention as described and illustrated in a preferred embodiment on a motorcycle shows the novelty and utility of such a multifunction braking and suspension device, such descriptions and claims as made here are not intended to limit the Applicant's invention to any particular vehicle or mode of transportation.

What is claimed is:

1. A motorcycle or other vehicle comprising:
A frame,
A rear wheel of said vehicle connected to the frame through an axle; and the axle and frame, to allow the wheel to rotate with respect to the axle and frame;
A brake rotor attached to the wheel;
A set of at least two brake pads attached to a caliper, typically and conventionally activated hydraulically by pistons or brake cylinders, and being a part of the conventional caliper assembly pressing against the brake pads and frictionally affecting the rotation of the rotor attached to the wheel and the motorcycle when said rear brake system is applied in order to slow or stop the motorcycle or other vehicle under braking;

2. A motorcycle or other vehicle as described in claim 1, further comprising an apparatus connected to the braking and rear suspension system of the vehicle for the purpose of substantially enhancing the braking and suspension of said vehicle and comprising a novel and utilitarian disc brake caliper housing and mount attached to a novel and utilitarian adjustable torque arm with each component of the subject invention attached to each other and to the frame and swingarm part of the frame of said motorcycle or other vehicle, whereby the intended use of said apparatus is to lower the center of the gravity of the motorcycle or other vehicle upon the application of the rear brakes or of the rear brakes and front brakes applied together.

3. An apparatus as recited in claim 2 wherein said brake caliper housing and mount, attached to the adjustable torque arm, and thence attached to various parts of the vehicle as shown in the enclosed drawings, FIGS. 1-A, 1-B, 2-A, 2-B, and FIGS. 3-A and 3-B, comprises a system and assembly able to substantially and favorably affect the braking effectiveness of the motorcycle or other vehicle, while simultaneously providing substantial suspension enhancements by lowering the vehicle and its center of gravity during forward motion braking conditions where both the rear brakes are applied, or the rear brakes and front brakes are applied together.

4. An apparatus as recited in claims 2 and 3, wherein said device operates to substantially lessen the tendency of the motorcycle or other vehicle to dive forward which without the Applicant's device, typically raises the rear of the vehicle, and lowers the front of the vehicle under braking conditions. Applicant's device includes a number of adjustment options for the rider or driver, utilizing the adjustable torque arm (5), (6) and (7) as illustrated in drawings 1-A through 3-B, and each adjustment of which on said torque arm will lower in increments the center of gravity of the vehicle under braking conditions, more than without the subject invention in place, giving the rider substantially safer control of the vehicle and simultaneously providing better braking effectiveness, allowing the vehicle to stop in a shorter distance than without the device in place.

5. An apparatus according to claims 1-4, wherein said device attaches to a motorcycle or other vehicle frame at various points in order to provide the greater efficiencies in braking and suspension under braking conditions as cited in those claims.

6. An apparatus according to claims 1-5, wherein said device comprises several points of attachment to each of the Applicant's invention's components, and to the motorcycle or other vehicle frame, through a system of bushings, bolts and nuts and other fasteners providing damping and anti-vibration functions, along with the characteristics cited in claims 2-4.

7. An apparatus, wherein the Applicant's device attaches to the motorcycle's or other vehicle's hydraulic braking system and the subject Applicant's invention provides both a housing and mounting for the hydraulic disc brake caliper on which are typically mounted and attached at least two disc brake pads which are effective as braking devices when applied hydraulically against both sides of a disc brake rotor which is typically attached to the wheel and/or axle of a motorcycle or other vehicle; the subject invention, acts in concert with the attached adjustable torque arm to accomplish the multiple functions of substantially lowering the center of gravity of the motorcycle or other vehicle while the vehicle is in forward motion and the rear brakes are applied or the front and rear brakes are applied together, allowing the subject invention disc brake caliper housing to substantially swing in the direction of the rear wheel travel while attached to the torque arm of the subject invention which is in turn attached to the upper part of the motorcycle frame, whereby the movement of the subject caliper housing and mount and the torque arm act in concert under said braking conditions to pull the rear part and the front part of the motorcycle frame downward, thereby lowering the vehicle's center of gravity and substantially altering the braking effectiveness and control of the vehicle.

8. An apparatus as recited in claim 1, wherein said device comprises: A disc brake caliper housing and mount for both the rear hydraulic disc braking system, including the caliper(s) and rotor(s) of the motorcycle, or other vehicle, and a mount for the adjustable torque arm of the subject invention both attached to the motorcycle or other vehicle frame.

9. An apparatus as recited in claims 1-8, wherein the functions of the device are related to both the braking and suspension qualities of the motorcycle because the vehicle, with the subject device in place, and under braking conditions while the vehicle is traveling in a forward direction, will experience both a lowered center of gravity as the rear brakes or the rear and front brakes together are applied, and because of the lowered center of gravity there will be a corresponding tendency of the vehicle not to “dive” forward on the front forks and springs of the motorcycle or other vehicle, and an ability of the driver of the vehicle to apply greater front braking, than without the device in place, while experiencing the lowering center of gravity function with the subject device in place while the rear brakes are also and at the same time applied.

10. An apparatus as recited in claims 1-9, wherein the functions of the device as described above, and in the enclosed drawings at FIGS. 3-A and 3-B, are enabled by the Applicant's disc brake caliper mount, with its attached torque arm, to move in a clockwise motion around the axle of the motorcycle or other vehicle while the vehicle is moving forward with the rear brakes applied, or the rear brakes and front brakes applied, and while the Applicant's disc brake caliper mount is moving in a clockwise direction, when viewed from the right side of the vehicle, said movement also pulls the torque arm downward; and because said torque arm is attached to the frame of the motorcycle or other vehicle, the downward pulling motion described here and illustrated in the enclosed drawings, FIGS. 3A and 3-B, also results in the downward motion of the vehicle relative to the front of the vehicle under said braking conditions. The inertial and rotational forward motion of the vehicle, with the Applicant's device attached, thus produce this downward motion because of the attachment and activation of the Applicant's device under rear braking, or rear and front braking, and effectively lowers the center of gravity of the vehicle, while simultaneously lessening the tendency of the vehicle to dive forward, as it would without the device attached.
